(19) United States
(12) Patent Application Publication
(10) Pub. No.: US 2013/0290934 A1
(43) Pub. Date: Oct. 31, 2013

(54) MONITORING APPLICATIONS EXECUTING ON A COMPUTER DEVICE USING PROGRAMMATIC TRIGGERS

(71) Applicant: Gregory Simon, San Francisco, CA (US)

(72) Inventor: Gregory Simon, San Francisco, CA (US)

(21) Appl. No.: 13/460,577

(22) Filed: Apr. 30, 2012

(51) Int. Cl. G06F 9/44

(52) U.S. Cl. 717/125; 717/127

(57) ABSTRACT

A method is disclosed for monitoring one or more applications that are executing on a computing device. A user is enabled to insert programmatic triggers in an application. One or more operations of the application is monitored during one or more durations that is determined by the programmatic triggers. An output is provided that is based on the monitored one or more operations.

### BACKGROUND OF THE INVENTION

As the number of consumers who own and use mobile devices increases, an immense number of different types of applications have been and are being created by developers across different platforms for different types of devices (e.g., for different smart phones or tablet devices).

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example system for monitoring one or more applications executing on a computing device, under an embodiment;

FIG. 2 illustrates an example method for monitoring one or more applications executing on a computing device, according to an embodiment;

FIG. 3 illustrates an example user interface feature for viewing data from monitored applications, under an embodiment;

FIG. 4 illustrates an example user interface feature for viewing data from monitored applications, under another embodiment; and

FIG. 5 illustrates an example hardware diagram for a system for monitoring one or more applications executing on a computing device, under an embodiment.

### DETAILED DESCRIPTION

Embodiments described herein include a system and method for monitoring applications and obtaining detailed information regarding the behavior of the monitored applications. A user (e.g., a programmer or developer of an application) can operate the profiler to monitor his or her application by inserting any number of probes into his or her application source code and/or the operating system code for the application (e.g., to monitor the operating system in conjunction with the application). A probe or programmatic trigger can be a code or code fragment that represents or corresponds to an event or operation of the application. Using the profiler, the user can monitor, for a period of time (e.g., 10 seconds), various operations designated by the probes (that have been inserted into the application code) in order to receive and/or record information corresponding to the operations that take place during this period of time. Because the user can insert probes in a variety of different locations of the application code, the profiler can, based on user preference, obtain information at both a high level system view and at low level system view. By using the data received from the monitored application, the developer is better able to debug his or her application or identify, for example, performance leaks in order to make the application run more efficiently.

According to an embodiment, one or more applications that are executing on a mobile computing device are monitored by the profiler. A user or developer is enabled to insert one or more programmatic triggers in the code of his or her application. The profiler monitors one or more operations of the application during one or more durations that is determined by the programmatic triggers. The programmatic triggers or probes are inserted into the application code to pass data to the profiler when the application performs various operations. Data can be passed from the application to the profiler via an application programming interface (API).

Any number of probes can be inserted into an application, a programmatic service, or library (e.g., each of these can be called a client). The implementation of the API can open a communication mechanism between the application and the profiler to enable the profiler to receive data from the monitored application based on the probes. The data provided by the probes can include a variety of information, e.g., what triggered an event or operation, the state of the data accessed by the application, and/or how much time an event or operation took.

In one embodiment, the profiler also processes the received data from the application(s) by copying the data to a memory resource or converting (e.g., translating) the data for providing on a user interface feature of the profiler. The profiler provides an output to the user that is based on the monitored one or more operations.

In one embodiment, the programmatic triggers or probes each correspond to an operation or event and can be named using a string metadata. This string metadata can be provided as part of the output so that the user can identify an operation when viewing and operating a user interface feature of the profiler. The probes can also contain a token or an opaque marker to properly pair a start event/operation and a stop event/operation.

According to some embodiments, the profiler includes a user interface feature on a display device that the user can interact with in order to enable the user to control the profiler. The user can begin monitoring an application and also cause the profiler to stop monitoring the application after a period of time. The user interface feature includes a selectable features that, when selected by the user, can cause the profiler to start monitoring (e.g., receive and/or record information) an application (e.g., a “record” button), or stop monitoring the application (e.g., a “stop” button). The user interface feature can also provide an output, based on the monitored operations of the application, to the user so that the user can navigate, identify, and analyze, etc., the data to better debug his or her application.

In some embodiments, when the user causes the profiler to start monitoring an application, the user can concurrently interact with the application to obtain specific data about a particular operation of the application. This enables the user to see certain events or operations that took place while the user interacted with the application and the user can view the data corresponding to these events or operations on the user interface feature of the profiler. In one embodiment, the data can be provided on the user interface feature as a time-based graph that illustrates each event that took place during the period of time the application was monitored.

The profiler is also capable of monitoring multiple applications simultaneously in a variety of different programming languages and/or frameworks (e.g., C, C++, and Javascript programming languages). By using probes that can be inserted into the operating system and application/program source code, the profile can be fully extensible at both the operating software and application layers.

Some embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources, including data ports, and signal lines (optical, electrical, etc.), unless stated otherwise.

One or more embodiments described herein provide that methods, techniques, and actions performed by a computing device or a system are performed programmatically, or as a computer-implemented method. Programmatically means through the use of code, or computer-executable instructions. A programmatically performed step may or may not be automatic.

Some embodiments described herein can generally require the use of computers, including processing and memory resources. For example, one or more embodiments described herein may be implemented, in whole or in part, on computing machines such as desktop computers, cellular phones, personal digital assistants (PDAs), laptop computers, printers, digital picture frames, and tablet devices. Memory, processing and network resources may all be used in connection with the establishment, use or performance of any embodiment described herein (including with the performance of any method or with the implementation of any system).

Some embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory, read-only memory (ROM), and magnetic memory. Computers (such as personal computers (PCs)), terminals, network enabled devices (e.g., mobile devices, such as cell phones) are all examples of machines and devices that utilize processors, memory, and instructions stored on computer-readable mediums.

System Overview

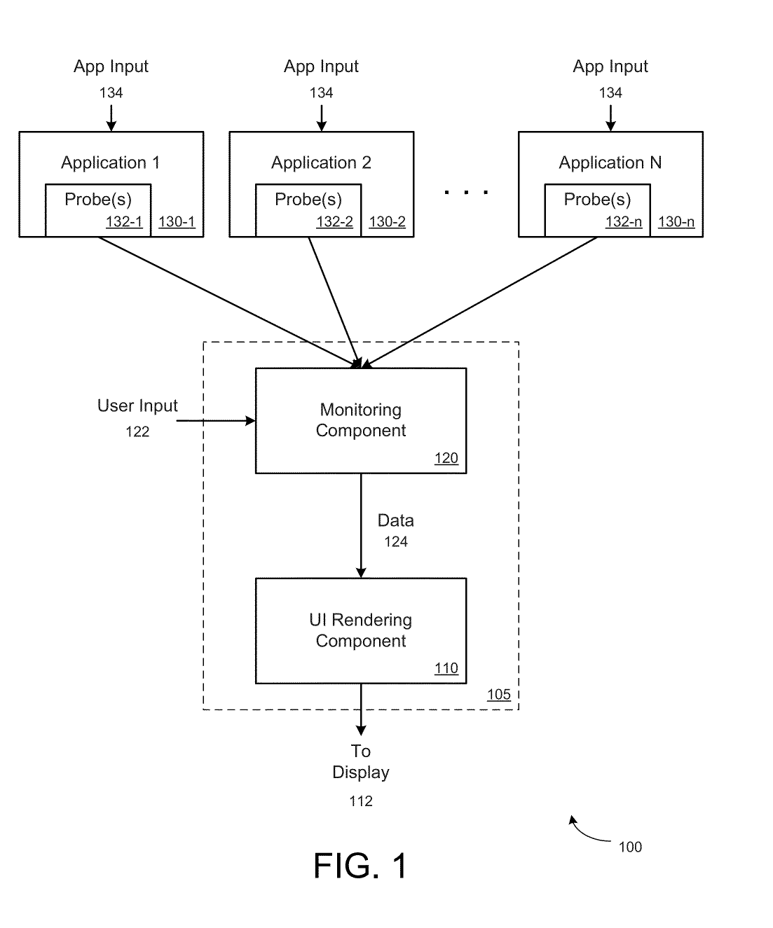

FIG. 1 illustrates an example system for monitoring one or more applications executing on a computing device, under an embodiment. A system such as described with respect to FIG. 1 can be implemented on, for example, a mobile computing device or small-form factor device, as well as computing form factors such as tablets, notebooks, desktops computers and the like. In one embodiment, the system 100 includes a profiler 105 that comprises a user interface (UI) rendering component 110 and a monitoring component 120. The profiler 105 operates as a tool that enables a user (or developer of an application) to obtain detailed information regarding the behavior of his or her application.

The profiler 105 includes a monitoring component 120 that monitors one or more applications 130-1, 130-2, 130-n, by receiving data from the applications via their respective probe(s) 132-1, 132-2, 132-n. A probe is a programmatic trigger that is implemented as a code or code fragment that is inserted into the source code of an application or the operating system software. The monitoring component 120 processes the data received from the one or more applications 130-1, 130-2, 130-n that is executing via the respective probes, and provides an output data 124 to the UI rendering component 110. The UI rendering component 110 provides a user interface feature via display data 112 that can be presented on a display of the system 100 to enable the user view information regarding the operation of the one or more applications 130-1, 130-2, 130-n (e.g., for debugging purposes).

The clients (e.g., application, service, or library) that are being monitored can be stored in and be executed on the same device as the profiler 105 or can be on different devices. For example, the developer can create application 130-1 to be used on a smart phone or tablet device. This application 130-1 and the profiler 105 can both be stored in a memory resource of a tablet device and operated on the tablet device. The user interface feature of the profiler 105 can also be provided on the same tablet device. In another embodiment, the user interface feature of the profiler 105 can be provided on a separate device (e.g., the separate device can be connected to the computing device that stores the profiler 105 and/or clients via a network or cable).

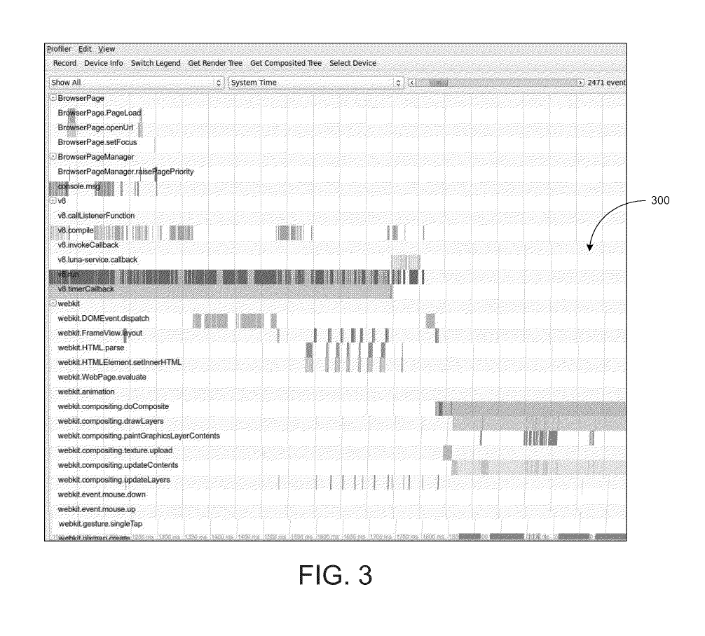

The monitoring component 120 can receive user input 122 via input mechanisms (e.g., through the user interface feature of the profiler 105) in order to enable the user to control the profiler 105. For example, the user can provide input 122 to cause the monitoring component 120 to begin monitoring (e.g., receive and/or record information) one or more applications (individually or simultaneously), and after a period of time (e.g., after a recording period), cause the monitoring component 120 to stop monitoring the applications. In some embodiments, the command to start and stop monitoring can be done remotely (over a network), automatically, or through the user interface feature of the profiler 105 (see e.g., FIG. 3). Processing and memory resources can be conserved by allowing the monitoring component 120 to monitor the behavior of various event and operations of the applications for a user selectable recording period (e.g., the user can choose to record for 10 s or 10 min instead of an hour).

In one embodiment, the user interface feature of the profiler 105 includes a set of icons or other user-interface features that, when selected by the user, cause the monitoring component 120 to start monitoring one or more applications 130-1, 130-2, 130-n. The set of features can include a menu item or separate icon (e.g., a “record” button) that is provided as part of the user interface feature. Similarly, the user interface feature can include a button or icon to cause the monitoring component 120 to stop monitoring the one or more applications 130-1, 130-2, 130-n (e.g., a “stop” button). In some embodiments, the “stop” button may only be provided on the user interface feature when the monitoring component 120 is currently monitoring the applications (e.g., show up where the “record” button used to be when the monitoring component 120 is currently monitoring).

The user can also provide user input 122 to control various settings and user interface features of the profiler 105. For example, in addition to controlling the monitoring period (e.g., a period of time to record information from an application), the user can access the user interface feature of the profiler 105 to after views, change legends or colors, select different devices or applications, after default settings, obtain more information about certain events or operation, scroll through data outputs, copy or save data, delete data, or display additional information or graphs. The monitoring component 120 can provide different formats and types of data to the UI rendering component 110 via data 124 based on the user input 122.

The profiler 105 is configured to communicate with one or more application 130-1, 130-2, 130-n via application programming interfaces (APIs). The one or more applications 130-1, 130-2, 130-n can include a program or application that is developed by a manufacturer of a device or created by a third party or individual developer. An application or program is software that is designed to help a user perform various tasks on a device. Applications can include, but are not limited to, for example, a phone application, an email application, a messaging application (SMS, MMS, IM, etc.), a browser application, a gaming application, an educational application, a reader, a media playing application, a photo application, a blogging application, a maps application, a document application, a financial or banking application, a news application, etc. The one or more applications 130-1, 130-2, 130-n can also include core device applications (e.g., applications that come with an operating system of a device by default from a manufacturer).

A developer of an application, including an existing application that he or she wants to modify, can use the profiler 105 (e.g., the server) to test the application to make sure that it is functioning properly and efficiently. In one embodiment, the developer can insert any number of probes 132-1, 132-3, 132-n into the source code of one or more applications 130-1, 130-2, 130-n, respectively, to monitor each of the various applications. Any number of these probes can be inserted into an application, a programmatic service, or library (e.g., a client). Each of the application, service, or library can be written in any language or framework that provides access to a client/server communication mechanism (such as Unix Berkeley sockets).

When a socket is opened between the profiler 105 and each of the one or more applications 130-1, 130-2, 130-n (as a result of the implementation of the APIs), the monitoring component 120 can receive data based on the probes 132-1, 132-3, 132-n, respectively. Each probe can represent or correspond to a particular event or operation that takes place or is performed by an application, programmatic service, or library. For example, probes can identify an operation that an application performs with a start event time and an end event time.

The profiler 105 can be used to monitor a variety of different operations of an application, service, or library. For example, in a variety of different operating software (e.g., iOS, Windows Mobile, webOS), common operations that can be monitored, recorded and outputted via the user interface feature include, for example, Javascript compilation, Javascript execution, HTML parsing, document object model (DOM) layout, image decoding, painting, touch events, timer callbacks, input/output operations, and system manager activity. This type of information can be useful to a developer in debugging his or her applications (and catching performance links), especially in performance problems.

When the monitoring component 120 receives a command to begin monitoring the one or more applications 130-1, 130-2, 130-n, the monitoring component 120 monitors start and stop events and instantaneous events for the probes 132-1, 132-3, 132-n that are inserted in the respective applications (or service or library). The start and stop events can be identified by the probes that are inserted in the application code. During the duration an event or operation (e.g., between a start and stop event probe), data for that event or operation can be provided to the monitoring component 120. This can occur for numerous events and operations for an application. In one embodiment, the user can interact with the one or more applications 130-1, 130-2, 130-n via the application input 134 while the applications are being monitored during a period of time. Because the user can insert probes in the source code of an application, the user can try to obtain information for a specific operation (e.g., an application searching a library) that is performed by the application.

For example, while the application is being monitored, the user can interact with that application to cause the particular operation to be performed via application input 134. When the application begins the operation (e.g., identified by a start event probe), the implementation of the API opens a communication channel between the application and the profiler 105, and pass data to the profiler 105 until the operation ends (e.g., identified by a stop event probe). During this event or operation time, the monitoring component 120 receives data corresponding to the operation from the probes, processes the data, and transmits data 124 to the UI rendering component 110. The UI rendering component 110 provides display data 112 for providing an output to the user (e.g., a user interface feature with a time-based graph). Data corresponding to the particular operation, such as when the operation was triggered, what state data came in, or how long the operation took (e.g., how long the application searched the library), can then be accessed and analyzed by the user.

In some embodiments, the developer or user can create an API for every language or framework he or she needs that identifies or exposes the following operations:

start(token, eventName, value)
stop(token, eventName, value)
event(eventName, value)
token_names([token,name] +)
is_active

These probes can be inserted in the source code of an application, service, or library to get information at a granular level (e.g., at a low level system view) or at a high level system view. The probes are described in detail below.

start: The client (e.g., application, service, or library) performs this operation to indicate that it is beginning an operation named eventName. token is an opaque identifier (e.g., a binary identifier) that is used to pair the operation with a corresponding stop. value is any string metadata associated with the start operation and is displayed to a user on the output via the user interface feature.

stop: The client performs this operation to indicate that it is ending an operation named eventName. token is an opaque identifier (e.g., a binary identifier) that is used to pair the operation with a corresponding and proceeding start. value is any string metadata associated with the stop operation and is displayed to a user on the output via the user interface feature.

event: The client performs this operation to indicate that an instantaneous event named eventName has occurred. value is any string metadata associated with the event operation and is displayed to a user on the output via the user interface feature.

token_names: The client can optionally perform this operation to provide names for tokens passed to start and stop operations. The names are provided as a set or array of token/name pairs. These names can then be displayed to a user on the output via the user interface feature. The tokens that are passed to start and stop operations can be some binary identifier (ID representing a token “75”). This token is much smaller data object than a string of letters for naming the token and is more easily passed to operations. The name for the token can then be provided at a later time.

is_active: Before invoking any other operation, the client can perform this operation to test whether the profiler 105 is currently active. Any computationally expensive work to create parameters to the start, stop, event, and token_names operations can be avoided if the profiler is inactive. In some embodiments, for is_active operation, the implementation of the API can attempt to open the client/server communication channel (e.g., between the profiler 105 and one or more applications, services, libraries) and indicate whether the operation succeeded or failed (depending on whether the profiler 105 is active or running). For optimal performance, the result of this test can be cached for a period of time, such as 1 s, before the test is repeated. Subsequent invocations of is_active prior to the expiration of the period of time can return the cached value instead of repeating the test.

In some embodiments, the probes can be left in the source code of the application, service, or library. When the profiler 105 is not running, there is no impact for having the probes left in the code. The probes become no-ops (e.g., no operation). The number of probes that can be inserted into a client is also not limited.

During a recording period, the data can be passed from the applications 130-1, 130-2, 130-n using a mutually agreed protocol, such as an XML or JSON schema, or a proprietary byte protocol, to the monitoring component 120. In one embodiment, the implementation of the API can open a client/server communication channel (such as a Berkeley socket) between the one or more applications 130-1, 130-2, 130-n and the profiler 105 to enable the profiler 105 to receive data from the monitored applications 130-1, 130-2, 130-n based on the probes 132-1, 132-3, 132-n, respectively. The API can be made available using a shared code mechanism, such as a Unix shared object library or Windows DLL. APIs are also provided for the C, C++, and Javascript programming languages. In some embodiments, once the API is defined and implemented, each client (e.g., each application, service, and/or library) would link against the shared code mechanism and inserted probes that indicate the start and stop of key operations and any instantaneous events. The clients can provide meaningful names for the start, stop, and instantaneous event operations, can provide meaningful metadata that is useful in assisting a user in debugging the source code of clients, and can provide meaningful names for the opaque identifier tokens.

The data that is provided to the monitoring component 120, which are based on the probes 132-1, 132-3, 132-n, include information such as what event or operation has been activated or began running, what triggered an event or operation, the state of data accessed by an event or operation, how long an operation or function took, etc. The data also includes time information (e.g., timestamps) so that the operations (such as the start, stop, event, and token_names operations) can be properly ordered and measured when viewed on the user interface feature of the profiler 105. In some embodiments, one timestamp can be for “wall” time, which is also known as stopwatch time, and the other for thread or operation time. For example, the “wall” time can show at what time an operation began from 0 seconds to 10 seconds (e.g., during the monitoring period of the monitoring component 120), and the thread time can show how long the operation took place (1.5 seconds).

The profiler 105 can be inactive until activated via a command, e.g., from the user input 122 to “record,” or from another command. When the profiler 105 is activated, the monitoring component 120 receives data from the clients (e.g., application, service, or library) via the opened client/communication mechanism and/or records the data it receives from the clients until the recording period or monitoring period ends (e.g., via the user clicking “stop recording” or a “stop” button on the user interface feature). At this time, the profiler 105 closes the client/server communication mechanism and passes the recorded data 124 to the UI rendering component 110.

In one embodiment, the monitoring component 120 can also process the data in real time as data arrives from the clients, or can do so after the recording period ends. Data can be processed by copying it to memory or writing it to a temporary file on disk, or by converting or translating the data. For example, if the data format between the one or more applications 130-1, 130-2, 130-n and the profiler 105 is different than the data format needed to provide to data 112 to be displayed on the user interface feature, the data format can be converted or translated by the monitoring component 120. The translation can be done in real time as data arrives from the one or more applications 130-1, 130-2, 130-n or after the monitoring period ends (e.g., after receiving data from the clients).

The UI rendering component 110 can receive data 124 from the monitoring component 120 and can arrange the data to be properly displayed on the user interface feature of the profiler 105. For example, data can be received from multiple applications concurrently. Using the timestamps, the UI rendering component 110 can reorder or rearrange the data, which can be received out of order, according to the “wall” timestamps and the thread time stamps provided. In other embodiments, the monitoring component 120 can organize and rearrange the data for proper viewing on the user interface feature. In some embodiments, the client/server communication mechanism can buffer data so that messages are not inadvertently lost.

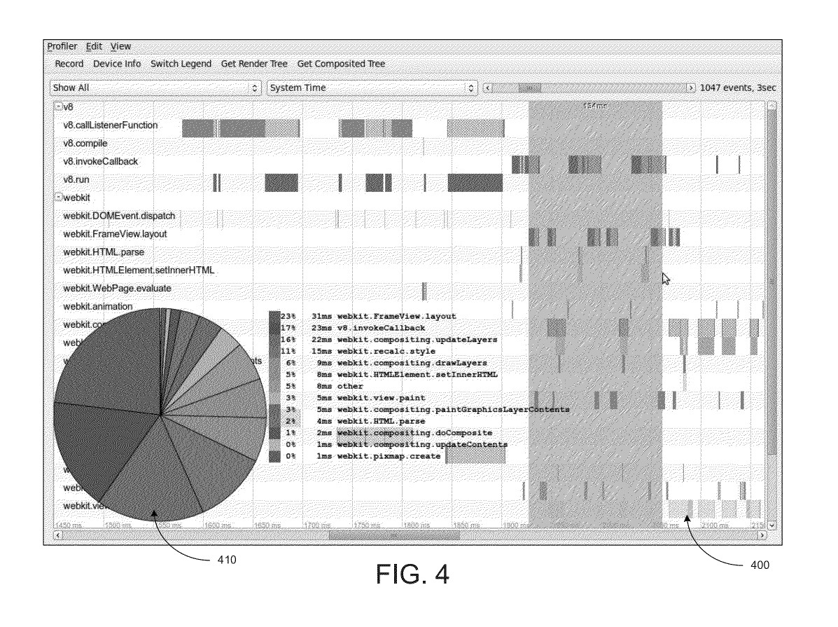

The UI rendering component 110 provides output 112, which is based on the information received from the monitoring component 120, to be presented on a user interface feature of the profiler 105. The information can be provided to a user in a variety of different ways. In one embodiment, the information can be displayed as a time-based graph (see FIG. 3). In other embodiments, the information can also be displayed with a pie graph or other graphs (see FIG. 4). The user is able to change the visualizations in order to view data for assisting in debugging his or her application. For example, in a time-based graph, the x-axis can represent time (e.g., in seconds) and the y-axis is listed with eventNames, as defined for start and stop events described above. Between the start and stop “wall” times, the time-based graph illustrates a plurality of events that took place during the recording period with different patterns and/or colors to indicate a parent event or a child event, etc., and different types of events. The user can also interact with the user interface feature to expand or collapse certain objects provided or change settings or views.

In some embodiments, the clients (e.g., application, service, or library) that are being monitored can be stored in and be executed on the same device as the profiler 105. In another embodiment, the profiler 105 can be remote from the clients and communicate with the clients across a computer network or link. For example, the developer can create his or her application to be used on a smart phone or tablet device. This application and the profiler 105 can both be provided on the smart phone and operated on the smart phone.

In some embodiments, the profiler 105, which is running on a computing device, can provide the user interface feature on the same computing device or on a separate device (e.g., the separate device can be connected to the computing device via a cable or wirelessly). For example, the developer may want to run or test her application as it would operate on a smart phone. The developer can load the application (with the inserted probes) on the smart phone, connect the smart phone to a computer (e.g., a PC) and operate a user interface feature for the profiler on the computer (e.g., click “record” to cause the profiler to start monitoring the application). The developer can then interact with the application for a brief period during the recording period (and then click “stop recording” on the user interface feature).

In some embodiments, the system 100 is also useful to developers who are developing an operating system, such as webOS, or programs for an operating system. The performance of core device applications, Javascript application framework, Webkit, and system managers can be improved using the system 100. A comprehensive view into the system activity can enable developers to discover and fix system interaction bugs that are not readily discoverable in isolation.

Methodology

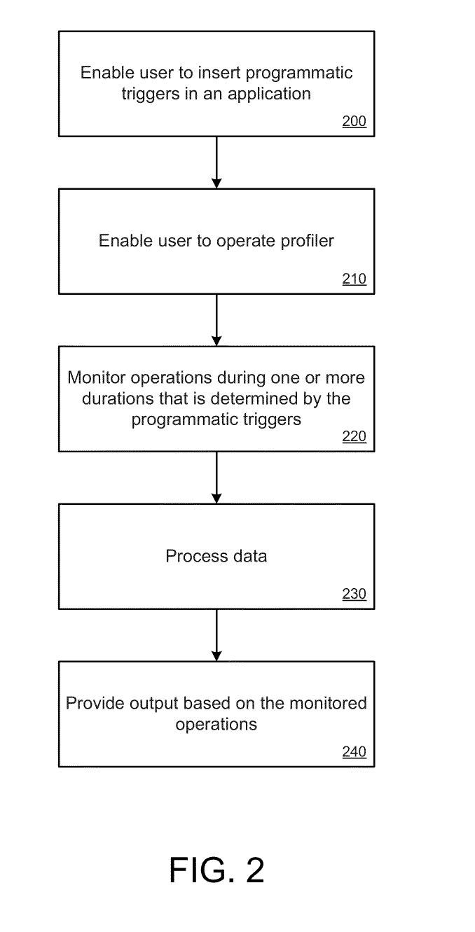

The method such as described by an embodiment of FIG. can be implemented using, for example, components described with an embodiment of FIG. 1. Accordingly, references made to elements of FIG. 1 are for purposes of illustrating a suitable element or component for performing a step or sub-step being described. FIG. 2 illustrates example method for monitoring one or more applications executing on a computing device, according to an embodiment.

In one embodiment, a user (e.g., developer of an application) is enabled to insert one or more programmatic triggers or probes in the source code of his or her application (step 200). The user may insert any number of probes in a variety of different locations in the source code to monitor the behavior of one or more events/operations that are performed by the application. The user can also insert the probes into services, libraries or other operating system applications or system managers to monitor the operating system as well as his or her application concurrently. For example, if an application developer wanted to debug an email application, the developer can insert numerous probes in the source code of the email application.

The user is enabled to operate the profiler via a user interface feature of the profiler (step 210). In some embodiments, the user interface feature of the profiler includes menus and menu items for controlling various facets of the profiler, changing settings, and viewing information and data monitored and recorded by the profiler. The user interface feature also provides a way for the user to start and stop the monitoring process. The user can operate the profiler by clicking (via a mouse, keyboard, touch screen, or other user input) on menu items and/or soft buttons to cause the profiler to begin monitoring one or more applications (e.g., receive and record data from the one or more applications based on the programmatic triggers). The user can also cause the profiler to stop monitoring the applications after a period of time. Referring back to the example, the application developer of the email application can use the profiler to monitor the behavior of the email application (as well as the behavior of other applications that are running on the device).

In response to the commands to start monitoring the clients (e.g., applications, services, libraries), the profiler can monitor one or more events, functions or operations (during one or more durations of time) that are performed by one or more clients (step 220). The profiler can monitor these events or operations based on the programmatic triggers or probes that are inserted in the source code of an application.

For example, the developer can click “record” on the user interface feature of the profiler to cause the profiler to start monitoring the email application. The developer can then interact with the email application, while the profiler is active, to perform certain tasks on the email application. As another example, the developer may want to see information and details of the events or operations that take place when she wants to compose a new email and when she begins to type in a recipient's email address. The programmatic triggers or probes would have been inserted by the developer to detect the occurrence of such events. The developer then operates the email application and clicks “compose message,” for example, and then begin typing an email address in the “To:” text box. The profiler can detect these events based on the programmatic triggers and monitor the operations that are being performed by the email application. During the duration of the “compose message” event or operation, for example, (e.g., based on the start and stop event probes), data for that event or operation can then be provided to the profiler from one or more clients. In some embodiments, operations can be performed during multiple durations due to an operation or event occurring during a time, and simultaneously, another event or operation taking place for a period of time (e.g., a child event stemming from a parent event).

In some embodiments, the profiler can process the data that is received from the clients (step 230). Data can be processed by copying it to memory or writing it to a temporary file on disk, or by converting or translating the data. The data processing can be done while the data is being received by the profiler or can be done after the recording/monitoring period ends.

The profiler provides the information, which is based on the monitored operations (e.g., the received data from the clients), as an output to the user via a user interface feature (step 240). The user can view the data as a time-based graph to see details of the operations or events that took place during the recording period. Detailed information regarding the behavior of multiple clients can be seen simultaneously on the user interface feature. This allows the developer to collect and analyze data to determine what functions or tasks are running or taking too much time, or see what events are occurring when they do not need to be. The developer can determine that some operations or sub-routines simply may not be necessary. In this way, the developer can discover and fix system interaction bugs that are not readily discoverable and improve performance of his or her application, as well as the performance of the operating system.

User Interface Feature

FIG. 3 illustrates an example user interface feature for viewing data from monitored applications, under an embodiment. In FIG. 3, a time-based graph 300 is presented as part of the user interface feature of the profiler. The user interface feature illustrates a visualization (e.g., output) of the data monitored and recorded by the profiler. The x-axis is time (shown in ms) and the y-axis is a set of events (shown by eventNames, as defined for the start and stop events described above with FIG. 1). The events are illustrated with a visualization of different patterns, shadings, and/or colors that indicates when an event took place during the monitoring period of time. The user can also select each of these bars or visualizations to expand and see additional information.

As illustrated in the user interface feature of FIG. 3, multiple menus and menu items are available for user control. A record button is available to enable the user to cause the profiler to begin monitoring the applications. Different drop down menus are available to after views of the time-based graph 300. In some embodiments, multiple devices can be connected to a personal computer (in which the user interface feature is provided with on a display), and the user can select which device's applications the profiler should monitor. The time-based graph 300 can be zoomed in, zoomed out or scrolled up or down. In one embodiment, during one event (e.g., a parent event), another event can begin (e.g., a child event), so that the child event is drawn on the time-based graph 300. At the same time, the parent event can continue to be shown on the graph, but in a different pattern to indicate that the child operation is also executing. Multiple child events can occur and be shown on time-based graph 300 (a child event off a child event, e.g.). For example, a user can change the visualization to thread time instead of “wall” time, and can collapse and expand related events.

FIG. 4 illustrates an example user interface feature for viewing data from monitored applications, under another embodiment. In FIG. 4, a time-based graph 400 is presented as part of the user interface feature of the profiler with a separate overlapping pie chart 410. The overlapping pie chart 410 can be provided on the user interface feature when the user selects a particular region on the time-based graph 400 (e.g., when 134 ms of the time-based graph 400 is selected, indicated by shaded region). For example, the pie chart 410 illustrates that during the 134 ms selected, the event, webkit.FrameView.layout, took place for 31 ms or 23% of the time. Each event is shown with a percentage and time duration as well as being indicated by different colors or patterns. In some embodiments, the user interface feature can include data, such as the total number of events or operations that took place (1047 events) and the recording time period (3 seconds). Using the data provided by the user interface feature, a developer can improve the performance of his or her application.

Hardware Diagram

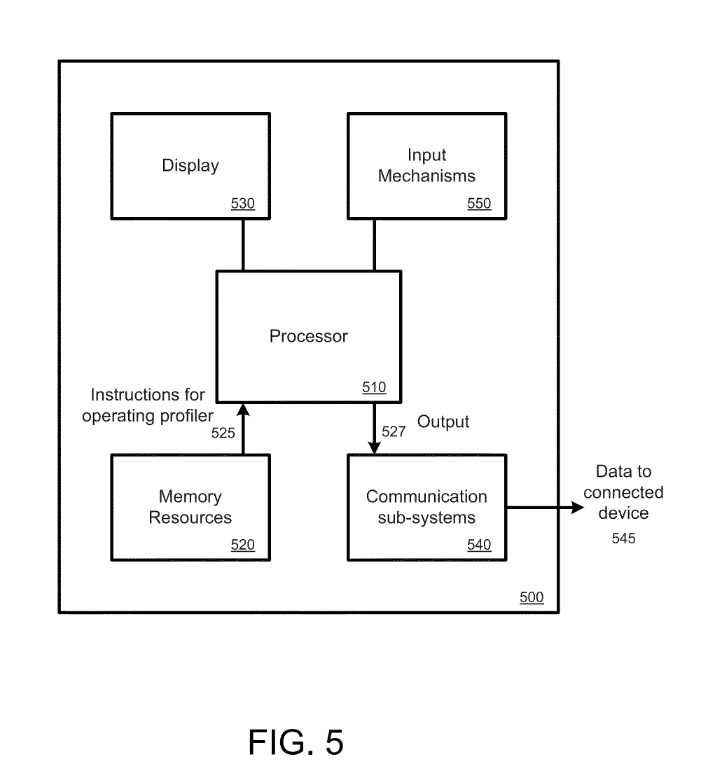

FIG. 5 illustrates an example hardware diagram that illustrates a computer system upon which embodiments described herein may be implemented. For example, in the context of FIG. 1, the system 100 may be implemented using a computer system such as described by FIG. 5. In some embodiments, the profiler 105 and one or more applications 130-1, 130-2, 130-n can be provided by the computing device 500.

In one embodiment, a computing device 500 may correspond to a mobile computing device, such as a cellular device that is capable of telephony, messaging, and data services. Examples of such devices include smart phones, handsets or tablet devices for cellular carriers. Computing device 500 includes a processor 510, memory resources 520, a display 530, one or more communication sub-systems 540 (including wireless communication sub-systems), and input mechanisms 550. In an embodiment, at least one of the communication sub-systems 540 sends and receives cellular data over data channels and voice channels.

The processor 510 is configured with software and/or other logic to perform one or more processes, steps and other functions described with embodiments, such as described by FIG. 1 through FIG. 4, and elsewhere in the application. Processor 510 is configured, with instructions and data stored in the memory resources 520, to implement the system 100 (as described with FIG. 1). For example, the profiler and the clients that are to be monitored by the profiler can be stored in the memory resources 520 of the computing device 500 (e.g., the source codes for applications, services, and/or libraries that have inserted programmatic triggers are stored in memory). The processor 510 can execute instructions for operating the profiler 525 and can provide an output 527 that corresponds to data monitored and/or collected by the profiler.

The processor 510 can provide content to the display 530, including the user interface feature of the profiler, by executing instructions stored in the memory resources 520. In some embodiments, the user interface feature of the profiler can be presented on another display of a connected device (e.g., a connected PC). The processor 510 can also provide the output 527 to the communications sub-systems 540 so that data 545 can be provided to a connected device. While FIG. 5 is illustrated for a mobile computing device, one or more embodiments may be implemented on other types of devices, including full-functional computers, such as laptops and desktops (e.g., PC).

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A method for monitoring execution of an application on a computing device, the method comprising:
enabling a user to insert programmatic triggers in the application;
monitoring one or more operations of the application during one or more durations that is determined by the programmatic triggers; and
providing an output that is based on the monitored one or more operations.

2. The method of claim 1, wherein monitoring one or more operations includes receiving data from the application for a period of time, the data including timestamps for at least one of the one or more operations.

3. The method of claim 2, further comprising enabling the user to select the period of time by providing one or more inputs to start and/or stop monitoring the one or more operations of the application.

4. The method of claim 1, wherein providing the output that is based on the monitored one or more operations includes providing a user interface feature that displays a time-based graph for the monitored one or more operations.

5. A system for monitoring execution of an application on a computing device, the system comprising:
a memory resource that stores instructions; and
one or more processors that use the instructions stored in the memory resource to provide:
a monitoring component for monitoring one or more operations of an application during one or more durations that is determined by programmatic triggers, the programmatic triggers having being inserted in the application by a user; and
a rendering component for providing an output that is based on the monitored one or more operations.

6. The system of claim 5, wherein the monitoring component monitors the one or more operations by receiving data from the application for a period of time, the data including timestamps for at least one of the one or more operations.

7. The system of claim 6, wherein the monitoring component further enables the user to select the period of time by providing one or more inputs to start and/or stop monitoring the one or more operations of the application.

8. The system of claim 5, wherein the rendering component provides the output that is based on the monitored one or more operations by providing a user interface feature that displays a time-based graph for the monitored one or more operations.

9. A computing device for monitoring execution of an application comprising:
one or more memory resources, the one or more memory resources storing an application that includes programmatic triggers that have been inserted by a user; and
one or more processors coupled to the memory resources to (i) monitor one or more operations of the application during one or more durations that is determined by the programmatic triggers, and (ii) provide an output that is based on the monitored one or more operations.

10. The computing device of claim 9, wherein the one or more processors monitors the one or more operations by receiving data from the application for a period of time, the data including timestamps for at least one of the one or more operations.

11. The computing device of claim 10, wherein the one or more processors further enables the user to select the period of time by providing one or more inputs to start and/or stop monitoring the one or more operations of the application.

12. The computing device of claim 9, wherein the one or more processors provide the output that is based on the monitored one or more operations by presenting a user interface feature that displays a time-based graph for the monitored one or more operations.
